(19) United States
(12) Patent Application Publication
(10) Pub. No.: US 2009/0313399 A1
(43) Pub. Date: Dec. 17, 2009

(54) DIRECT MEMORY ACCESS CHANNEL

(75) Inventors: Srinivas LINGAM, Dallas, TX (US); Seok-Jun LEE, Allen, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/479,070

(22) Filed: Jun. 5, 2009

Related U.S. Application Data
(60) Provisional application No. 61/061,270, filed on Jun. 13, 2008.

(51) Int. Cl. G06F 13/28

(52) U.S. Cl. 710/26; 710/22; 710/52

(57) ABSTRACT

A system and method for using a direct memory access (“DMA”) channel to reorganize data during transfer from one device to another are disclosed herein. A DMA channel includes demultiplexing logic and multiplexing logic. The demultiplexing logic is configurable to distribute each data value read into the DMA channel to a different one of a plurality of data streams than an immediately preceding value. The multiplexing logic is configurable to select a given one of the plurality of data streams. The DMA channel is configurable to write a value from the given data stream to a storage location external to the DMA channel.

The present application claims priority to and incorporates by reference provisional patent application 61/061,270, filed on Jun. 13, 2008, entitled “Dual-addressed DMA with Interleaved Data for SIMD Processors.”

### BACKGROUND

Direct Memory Access (“DMA”) is a method for direct communication between, for example, memory devices, a peripheral device and a memory device, or two peripheral devices. DMA is often employed to offload routine data movement tasks from a higher level entity (e.g., a processor), thus freeing the higher level entity to perform other tasks while DMA performs the data movement. Using DMA, data values are moved by a DMA device (i.e., a DMA controller) in accordance with a set of parameters provided by the higher level entity. The parameters can include, for example, a data source address, a data destination address, address increment values, and an amount of data to be moved from source to destination.

A DMA controller typically includes one or more DMA channels. Each DMA channel is capable of performing a requested sequence of data movements. A DMA channel gains control of the various interconnection structures (e.g., buses) over which data is being moved, accesses the storage devices connected to the buses, and notifies an external device (e.g., a processor) when the requested data movements are complete.

In some systems, DMA channels are employed to move data to be processed by a processor from slower devices to faster devices (e.g., to memory internal to or closely coupled to a processor), and to move processed data from faster devices to slower device to optimize processor utilization. Unfortunately, data movement operations provided by conventional DMA channels may be insufficient to optimize processor utilization in some applications.

### SUMMARY

Various systems and methods for using a direct memory access (“DMA”) channel to reorganize data during transfer from one device to another are disclosed herein. In some embodiments, a DMA channel includes demultiplexing logic and multiplexing logic. The demultiplexing logic is configurable to distribute each data value read into the DMA channel to a different one of a plurality of data streams than an immediately preceding value. The multiplexing logic is configurable to select a given one of the plurality of data streams. The DMA channel is configurable to write a value from the given data stream to a storage location external to the DMA channel.

In accordance with at least some other embodiments, a method includes storing data values read into a DMA channel in a plurality of DMA channel storage queues. A plurality of sequential address sets are generated. Each address set corresponds to a queue and identifies sequential memory locations external to the DMA channel in which corresponding queue data is stored.

In accordance with yet other embodiments, a system includes a processor, memory and a DMA channel. The memory is coupled to the processor, and the DMA channel is coupled to the memory and to the processor. The DMA channel is configurable to deinterleave data values consecutively read into the DMA channel into a plurality of data streams, and to store each deinterleaved data stream in a series of sequential locations in the memory.

### BRIEF DESCRIPTION OF THE DRAWINGS

For a detailed description of exemplary embodiments of the invention, reference will now be made to the accompanying drawings in which:

FIG. 1 shows an exemplary block diagram of a system that includes direct memory access (“DMA”) for moving data between an external data source/sink and memory accessible to a processor in accordance with various embodiments;

FIG. 2 shows an exemplary block diagram of processor system that includes an interleaving/deinterleaving DMA channel in accordance with various embodiments;

FIG. 3 shows a flow diagram for a method for deinterleaving data while moving the data from an external data source into a memory coupled to a processor via a DMA channel in accordance with various embodiments; and

FIG. 4 shows a flow diagram for a method for interleaving data while moving data from a memory coupled to a processor to an external data source via a DMA channel in accordance with various embodiments.

### Notation and Nomenclature

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein are systems and methods for optimizing processor utilization by using a direct memory access (“DMA”) channel to deinterleave data values read into a memory accessible by the processor, and/or to interleave data values read from the memory. Direct memory access (“DMA”) channels are used to move data between data storage devices. One particular application of a DMA channel is intended to optimize utilization of a processor by using the DMA channel to move data values between fast memory closely coupled to the processor and a slower device. While useful, simply moving data using the DMA channel may be insufficient to provide optimal processor performance. For example, if the DMA channel stores the data in memory in a sequence that requires inefficient processor access methods, processor cycles will be wasted on data access that could have been used elsewhere.

Embodiments of the present disclosure provide improved processor utilization by rearranging data values moved between a processor-accessible memory and a remote data source/sink. Embodiments of a DMA channel disclosed herein provide for deinterleaving a sequence of data values moved from a data source to processor accessible memory to allow the processor to efficiently read the data, resulting in improved processor utilization. Embodiments also provide for interleaving multiple data sets written by the processor to memory as the DMA channel moves the data sets from memory to a data sink.

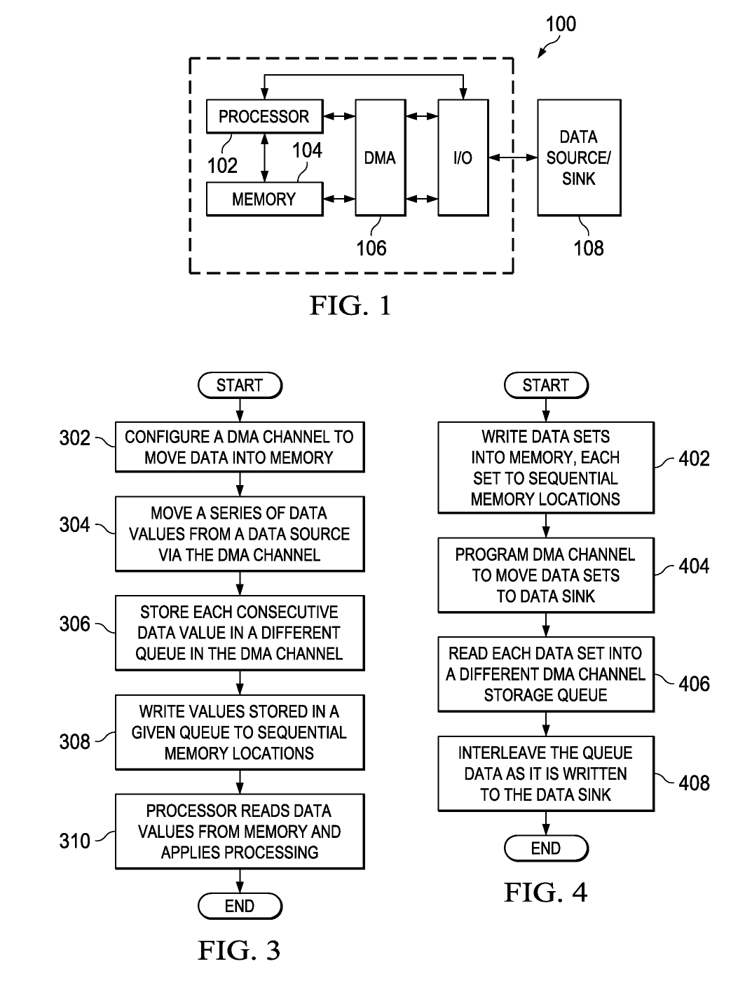

FIG. 1 shows an exemplary block diagram of a system 100 that includes a direct memory access (“DMA”) channel 106 for moving data between an external data source/sink 108 and memory 104 coupled to a processor 102 in accordance with various embodiments. The processor 102 may be any device configured to execute software instructions, such as, a digital signal processor, a general-purpose processor, a microcontroller, etc. The components of a processor 102 can generally include execution units (e.g., integer, floating point, application specific, etc.), storage elements (e.g., registers, memory, etc.), peripherals (interrupt controllers, clock controllers, timers, serial I/O, etc.), program control logic, and various interconnect systems (e.g., buses).

The memory 104 is coupled to the processor 102. The memory 104 may be configured to minimize processor access time. For example, the memory 104 may be configured to provide single clock cycle processor accesses at the maximum processor clock frequency. Various random access memory (“RAM”) technologies can be used, for example, static RAM (“SRAM”), dynamic RAM (“DRAM”), etc.

The DMA channel 106 is coupled to the processor 102 and to the memory 104. The processor 102 programs the DMA channel 106 to move data into or out of the memory 104 while the processor 102 performs other tasks. DMA channel 106 programming may be provided by, for example, having the processor 102 write programming values into registers or memory in the DMA channel 106 and/or by having the processor write programming values into the memory 104 that are retrieved by the DMA channel 106 and thereafter loaded into DMA channel 106 internal registers. Exemplary DMA channel programming values include source address, destination address, source or destination address increment, number of values to move, etc.

The data source/sink 108 represents a device that provides data to and/or receives data from the DMA channel 106. The data source/sink 108 can be, for example, a memory, a peripheral (e.g., an analog-to-digital converter or digital to analog converter), an I/O interface of another processor, etc.). Generally, the data source/sink 108 will provide data in a predetermined sequence and/or expect data received to be organized according to a predetermined arrangement. Unfortunately, the predetermined data sequences provided or expected by the data source/sink 108 may not be the optimal sequence for use by the processor 102 (e.g., may not provide for optimal processor utilization).

The DMA channel 106 is configured to rearrange data read from an external source (e.g., the data source/sink 108) as the data passes through the DMA channel 106. Thus, the DMA channel 106 writes the data read from the data source/sink 108 into memory 104 in a sequence that allows efficient access by the processor 102. Similarly, the DMA channel 106 is configured to rearrange data read from the memory 104 as the data passes through the DMA channel 106 to the data source/sink 108, allowing the processor 102 to efficiently write the data into the memory 104 without regard to the arrangement expected by the data source/sink 108. In at least some embodiments, the DMA channel 106 is configured to deinterleave data values read (i.e., distribute consecutively read data values to different data streams) from the data source/sink 108 as the data traverses the DMA channel. In some embodiments, the DMA channel 106 may be configured to interleave data streams read from different areas of memory 104 as the streams pass through the DMA channel 102 to the data source/sink 108.

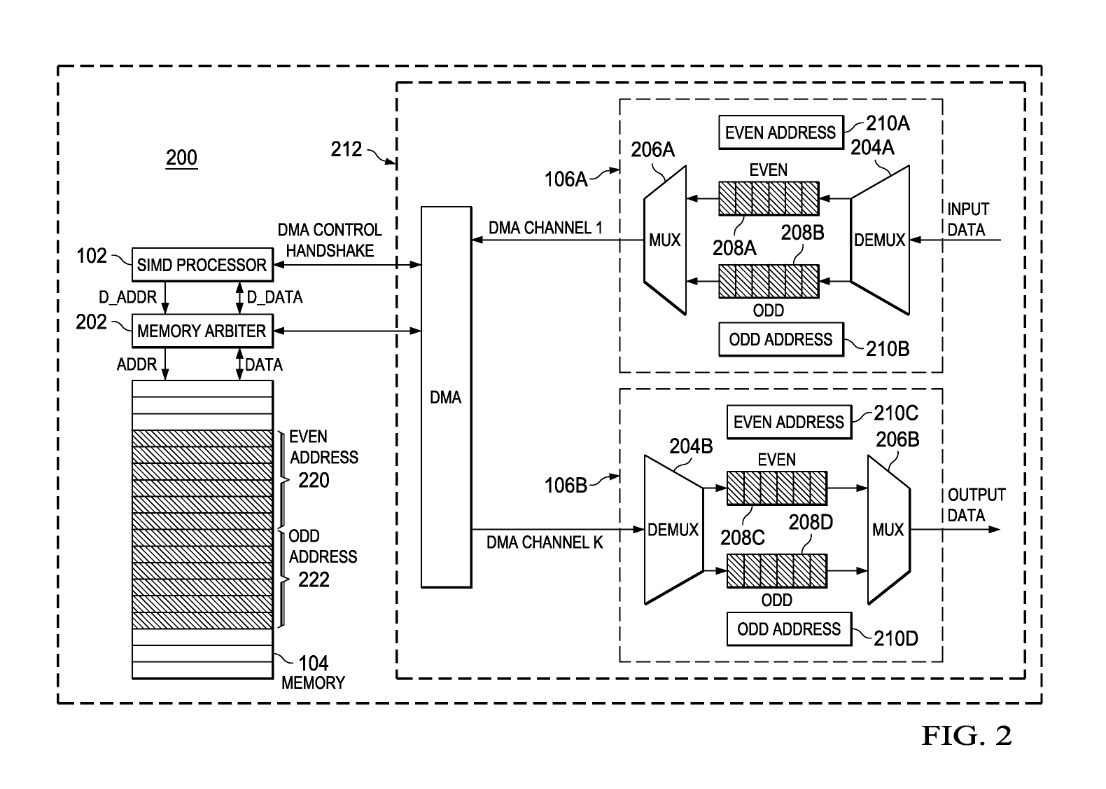

FIG. 2 shows an exemplary block diagram of processor system 200 that includes an interleaving/deinterleaving DMA controller 212 in accordance with various embodiments. In the system 200, the processor 102 is shown as a single instruction multiple data (“SIMD”) processor. SIMD processors simultaneous apply a single instruction to multiple data values. Consequently, SIMD processors can be used to efficiently implement various data processing algorithms, for example, physical layer processing algorithms in high-performance wireless receivers. SIMD processors can efficiently access data stored in contiguous locations of the memory 104, but may not be able to efficiently access data not stored in contiguous memory 104 locations.

The processor 102 and the DMA Controller 212 are coupled to the memory 104 via a memory arbiter 202. The memory arbiter 202 controls which of the processor 102 and the DMA controller 212 is allowed to access the memory 104 at a given time.

The DMA controller 212 can include a plurality of DMA channels 106 each capable of independent operation. Two DMA channels 106A and 106B are illustrated, but in practice, the DMA controller 106 may include one or more DMA channels. Each DMA channel 106A, 106B includes demultiplexing logic 204A, 204B, multiplexing logic 206A, 206B, a plurality of data storage queues 208A, 208B, 208C, 208D, (e.g., first-in-first-out memories), and an address generator 210A, 210B, 210C, 210D respectively associated with each of the queues 208A, 208B, 208C, 208D. As a matter of convenience, each of the DMA channels 106A, 106B is illustrated with two queues and two address generators; however, embodiments of the DMA channel 106 are not limited to any particular number of queues or address generators.

The DMA channel 106A is shown configured to move data from the data source/sink 108 to the memory 104. The processor 102 can program the DMA channel 106A by providing an address indicating a data source (e.g., the address of the data source 108), an address of a location to which data is to be moved (e.g., an address in the memory 104), and a number of data values to be moved. As data values are transferred through the DMA channel 106A, the demultiplexing logic 204A can cause each consecutive data value to be written to a different one of the queues 208A, 208B in the channel 106A. For example, data value N may be stored in the queue 208A, data value N+1 stored in the queue 208B, and data value N+2 stored in the queue 208A. The demultiplexing logic 204A can be any logic structure that deinterleaves the received data in multiple data streams by distributing consecutively received data values to different queues 208A-B in the DMA channel 106A.

The multiplexing logic 206A is coupled to an output of each queue 208A, 208B. The multiplexing logic 206A selects the output of a given queue 208A-B to be written to contiguous locations (i.e., sequential addresses) of the memory 104. The address generators 210A-B provide sequential addresses for writing the data values read from the respective queues 208A-B to contiguous memory 104 locations.

Thus, given the dual queues 208A-B of the DMA channel 106A, the input data values read from the data source/sink 108 are partitioned into two data streams via the demultiplexing logic 204A. A first stream may comprise odd numbered data values, and a second stream may comprise even numbered data values. Even and odd streams are buffered in corresponding even and odd storage queues 208A-B. The data stream stored in the even storage queue 208A may be routed through the multiplexing logic 206A and written to contiguous locations 220 of the memory 104 using sequential addresses generated by the even address generator 210A. Similarly, the data stream stored in the odd storage queue 208B may routed through the multiplexing logic 206A and written to contiguous locations 222 of the memory 104 using sequential addresses generated by the odd address generator 210B. Thereafter, the processor 102 can access sequential values of each of the even and odd data streams stored in the memory 104 by accessing sequential memory 104 locations.

The DMA channel 106B is shown configured to move data from the memory 104 to the data source/sink 108. The data source/sink 108 expects an interleaved data stream to be provided. However, processor 102 is most efficient when writing a contiguous data stream. Advantageously, the DMA channel 106B is configured to provide an interleaved data stream to the data source/sink 108.

The processor 102 writes data values to contiguous locations of the memory 104. Each set of data values written to contiguous memory 104 locations can comprise a data stream. Thus, data values stored in contiguous memory 104 locations 220 may be labeled the even stream, and data values stored in contiguous memory 104 locations 222 may be labeled the odd stream. The processor 102 can program the DMA channel 106B by providing an address indicating a data destination (e.g., the address of the data sink 108), an address of a data source (e.g., an address in the memory 104), and a number of data values to be moved.

As data values are transferred through the DMA channel 106B, the demultiplexing logic 204B causes values of each data stream to be stored in the corresponding queue 208C, 208D. The address generators 210C, 210D respectively associated with queues 208C, 208D generate sequential addresses used to address the contiguous memory 104 locations 220, 222. Thus, when the even data stream stored in contiguous memory 104 locations 220 is read using even address generator 210C, the data values are stored in the even storage queue 208C. Similarly, when the odd data stream stored in contiguous memory 104 locations 222 is read using odd address generator 210D, the data values are stored in the odd storage queue 208D.

Multiplexing logic 206B is coupled to an output of each queue 208C-D. In the DMA channel 106B, the multiplexing logic 206B is configured to alternately provide a data value from each of the even and odd queues 208C-D, thus interleaving the even and odd data streams read from the memory 104.

Given the dual queues of the DMA channel 106B, the input data values are written to the memory 104 as two distinct data streams. The first stream (labeled even) is stored in contiguous memory 104 locations 220. The second stream (labeled odd) is stored in contiguous memory 104 locations 222. Even and odd streams are read into the DMA channel 106B using address generators 210C-D to address the memory 104. The even data stream read from memory 104 contiguous locations 220 is buffered in even storage queue 208C. The odd data stream read from memory 104 contiguous locations 222 is buffered in odd storage queue 208D. The demultiplexing logic 204B controls the routing of data values from the memory 104 to the storage queues 208C-D. The multiplexing logic 206B interleaves the even and odd data streams as data is provided to the data sink 108.

Thus, embodiments of the DMA channel 106 free the processor 102 from the burden of performing deinterleaving and/or interleaving of data streams, and allow the processor 102 to access sequential data streams in the memory 104. Consequently, embodiments of the present disclosure provide improved processor 102 utilization.

FIG. 3 shows a flow diagram for a method for deinterleaving data while moving the data, via a DMA channel 106, from an external data source 108 into a memory 104 coupled to a processor 102 in accordance with various embodiments. Though depicted sequentially as a matter of convenience, at least some of the actions shown can be performed in a different order and/or performed in parallel. Additionally, some embodiments may perform only some of the actions shown.

In block 302, the DMA channel is configured (e.g., as channel 106A) to move data into the memory 104 and to change the sequence of the data as it is moved. A processor 102 configures the DMA channel 106A by providing various parameters, such as source/destination addresses, address increments, and amount of data to be moved. Embodiments of the DMA Channel 106A may load destination address values into the address generators 210A-B.

In block 304, the DMA channel 106A retrieves a series of data values from the data source 108. The data source may be a memory, a peripheral device, a processor, etc.

In block 306, the DMA channel 106A stores each consecutive data value read from the data source 108 in a different DMA channel storage queue 208A-B. The DMA channel 106A may include two or more data storage queues. Provision of the data values to the various storage queues may be directed by demultiplexing logic 204A coupled to the inputs of the queues. The DMA channel 106A thus divides the data values read from the data source 108 into a plurality of data streams.

In block 308, values stored in each queue 208A-B are written to sequential storage location of the memory 104. For example, data values stored in the queue 208A are stored in consecutive locations 220 of the memory 104, and data values stored in the queue 208B are stored in consecutive locations 222 of the memory 104. The location in the memory 104 where each data value read from a queue 208A-B is stored is determined by a respective address generator 210A-B. A queue 208A-B, and respective address generator 210A-B, is selected for writing by the multiplexing logic 206A or equivalent data selection logic.

In block 310, the interleaved data stream provided by the data source 108 has been deinterleaved by the DMA channel 106A and stored in memory 104 as a plurality of sequential data streams. The processor 102 reads each sequential data stream by accessing consecutive memory 104 locations and applies processing the data values.

FIG. 4 shows a flow diagram for a method for interleaving data while moving data, via a DMA channel 106, from a memory 104 coupled to a processor 102 to an external data sink 108 in accordance with various embodiments. Though depicted sequentially as a matter of convenience, at least some of the actions shown can be performed in a different order and/or performed in parallel. Additionally, some embodiments may perform only some of the actions shown.

In block 402, the processor 102 writes a plurality of data sets into the memory 104. Each data set is written into consecutive locations of the memory 104. For example, a first data set may be stored in consecutive memory 104 locations 220, and a second data set may be stored in consecutive memory 104 locations 222.

In block 404, the processor 102 configures the DMA channel 106 to move the data sets stored in the memory 104 to the external data sink 108. The data sink 108 may expect the data it receives to include interleaved data streams. Consequently, the DMA channel 106 may be configured, for example, to operate as the DMA channel 106B, and to interleave the data sets read from the memory 104 during the transfer. Configuring the DMA channel 106B may include providing source/destination addresses, address increment values, and the amount of data to be moved. The address generators 210C-D may be programmed with the source addresses for each the data sets stored in the memory 104. For example, the address generator 210C may be stored with the address of the data set stored in consecutive memory 104 locations 220, and the address generator 210D may be stored with the address of the data set stored in consecutive memory 104 locations 222.

In block 406, the data sets are read from the memory 104 and stored in the DMA channel queues 208C-D. Each data set is stored in a different queue 208C-D. For example, the data set stored in memory 104 locations 220 may be stored in the even queue 208C, and the data set stored in memory 104 locations 222 may be stored in the odd queue 208D. Routing of the data into a queue 208C-D is controlled by the demultiplexing logic 204B coupled to the queue 208C-D inputs.

In block 408, data values are read from the queues 208C-D in alternate fashion (i.e., a value is read from queue 208C, subsequently a value is read from queue 208D, etc.). Thus, the data stored in the queues 208C-D are interleaved. The interleaved data values are provided to the data sink 108. The multiplexing logic 206B controls the interleaving of the queue 208C-D outputs.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A direct memory access (“DMA”) channel, comprising:
demultiplexing logic configurable to distribute each data value read into the DMA channel to a different one of a plurality of data streams than an immediately preceding data value; and
multiplexing logic configurable to select a given one of the plurality of data streams;
wherein the DMA channel is configurable to write a value from the given data stream to a storage location external to the DMA channel.

2. The DMA channel of claim 1, wherein the demultiplexing logic is configurable to provide a series of consecutive data values read into the DMA channel to one of the plurality of data streams.

3. The DMA channel of claim 1, further comprising a plurality of address generators, each address generator corresponds to one of the plurality of data streams, each address generator provides sequential addressing for data values moving between the corresponding data stream in the DMA channel and memory external to the DMA channel.

4. The DMA channel of claim 1, further comprising a plurality of storage queues coupled between an output of the demultiplexing logic and an input of the multiplexing logic, each queue configured to buffer one of the plurality data streams.

5. The DMA channel of claim 4, wherein the multiplexing logic is configurable to provide an output of each queue, and the DMA channel is configurable to write the output of each queue to sequential memory locations external to the DMA channel.

6. The DMA channel of claim 4, wherein the multiplexing logic is configurable to alternately provide a single data value from each of the plurality queues, and the DMA channel is configurable to sequentially write data values alternately read from each of the plurality of queues to memory external to the DMA channel.

7. The DMA channel of claim 1, wherein the DMA channel is configurable to deinterleave a read data stream into a plurality of write data streams, and to interleave a plurality of read data streams into a single write data stream.

8. A method, comprising:
storing data values read into a DMA channel in a plurality of DMA channel storage queues;
generating a plurality of sequential address sets, each set corresponding to a queue and identifying sequential memory locations external to the DMA channel in which corresponding queue data is stored.

9. The method of claim 8, further comprising storing each consecutive data value read into the DMA channel in a different one of the plurality of DMA channel storage queues.

10. The method of claim 9, further comprising providing the output of each queue to sequential memory locations outside the DMA channel.

11. The method of claim 8, further comprising storing in each of the plurality of storage queues a set of data values read from a different series of consecutive memory locations external to the DMA channel.

12. The method of claim 11, further comprising providing, alternately, an output value from each of the plurality storage queues to a storage location external to the DMA channel.

13. The method of claim 8, further comprising providing to the DMA channel, a plurality of addresses, each address comprising one of a memory location where the DMA channel is to write a data stream deinterleaved in the DMA channel, and a memory location where the DMA channel is to read a data stream to be interleaved by the DMA channel.

14. A system, comprising:
a processor;
a memory coupled to the processor; and
a DMA channel coupled to the memory and the processor;
wherein the DMA channel is configurable to deinterleave data values consecutively read into the DMA channel into a plurality of data streams, and to store each deinterleaved data stream in a series of sequential locations in the memory.

15. The system of claim 14, further including software programming executed by the processor that separately processes each plurality of data streams stored in sequential memory locations by the DMA channel.

16. The system of claim 14, wherein the DMA channel comprises a plurality of address generators, each address generator corresponds to one of the plurality of data streams, and each address generator provides sequential addressing for data values moving between the corresponding data stream and the memory.

17. The system of claim 14, wherein the DMA channel comprises demultiplexing logic configurable to distribute each consecutive data value read into the DMA channel to a different one of the plurality of data streams and configurable to provide a series of consecutive data values read into the DMA channel to one of the plurality of data streams.

18. The system of claim 14, wherein the DMA channel further comprises:
Multiplexing logic configurable to select a given one of the plurality of data streams; and
a plurality of queues coupled between the demultiplexing logic and the multiplexing logic, each queue configured to buffer one of the plurality data streams.

19. The system of claim 18, wherein the multiplexing logic is configurable to provide an output of each queue, and the DMA channel is configurable to write the output of each queue to sequential locations of the memory.

20. The system of claim 18, wherein the multiplexing logic is configurable to alternately provide a single data value from each of the plurality queues, and the DMA channel is configurable to write data values alternately read from each of the plurality of queues to sequential locations of the memory.
